(19) United States
(12) Patent Application Publication
(10) Pub. No.: US 2022/0170138 A1
(43) Pub. Date: Jun. 2, 2022

(54) ALUMINUM ALLOY FOR CASTING AND ADDITIVE MANUFACTURING OF ENGINE COMPONENTS FOR HIGH TEMPERATURE APPLICATIONS

(71) Applicant: GM Global Technology Operations LLC, Detroit, MI (US)

(72) Inventors: Qigui Wang, Rochester Hills, MI (US); Dale A. Gerard, Bloomfield Hills, MI (US); Devin R. Hess, Clarkston, MI (US); Herbert W. Doty, Fenton, MI (US); Daniel J. Wilson, Linden, MI (US)

(21) Appl. No.: 17/109,746

(22) Filed: Dec. 2, 2020

(51) Int. Cl. C22C 21/16; F02F 1/24; B22F 5/00; B22F 1/00; B22F 3/105

(52) U.S. Cl. CPC C22C 21/16; F02F 1/24; B33Y 80/00; B22F 1/0011; B22F 3/1055; B22F 5/008

(57) ABSTRACT

An aluminum alloy is disclosed that is suitable for casting and additive manufacturing processes. The aluminum alloy may be used in the casting and additive manufacturing of engine blocks and/or cylinder heads of modern internal combustion engines. The aluminum alloy exhibits improved ductility and fatigue properties suitable for elevated operating temperatures from about 250° C. to 350° C. The alloy includes about, by weight, 4-10% Copper (Cu), 0.1-1.0% Manganese (Mn), 0.2 to 5% Magnesium (Mg), 0.01-1.0% Cerium (Ce), 0.01-2% Nickel (Ni), 0.01-0.8% Chromium (Cr), 0.01-1.0% Zirconium (Zr); 0.01-1.0% Vanadium (V), 0.01-0.3% Cobalt (Co), 0.01-1.0% Titanium (Ti), 1-200 ppm Boron (B), 1-200 ppm Strontium (Sr), 0.5% max Iron (Fe), 0.1% max other trace elements, and balance of aluminum (Al).

### INTRODUCTION

The present disclosure relates to aluminum alloys, in particular to aluminum alloys for high temperature applications, and more particularly to aluminum alloys suitable for casting and additive manufacturing of engine components.

Aluminum alloys have been increasingly used in the automotive industry to replace iron alloys to reduce mass in the manufacturing of engine components such as engine blocks and cylinder heads. Conventional, aluminum alloys such as A356, 319, and AS7GU (A356+0.5% Cu), as provided by American and/or European Aluminum Alloy standards, are known to be used in casting engine blocks and engine heads. Traditional internal combustion engines have an operating temperature in the range of approximately 160° C. to 190° C. Engine blocks and cylinder heads cast from these conventional aluminum alloys exhibit good ductility and fatigue properties for operation within the aforementioned temperature range.

Modern light weight and fuel efficient engines have significantly increased power densities, exhaust temperatures, and peak cylinder pressures resulting in elevated operating temperatures of between 250° C. to 350° C., which is significantly above the traditional 160° C. to 190° C. range. The higher operating temperatures of modern engines require engine blocks and heads to be manufactured of aluminum alloys having a higher tensile, creep, and fatigue strength than of that of conventional casting aluminum alloys. Furthermore, modern engine components also have intricate geometries for valve seats, piston crowns, cylinder heads, etc., that may not be achieved by casting and machining alone, but might be achieved by additive manufacturing.

Thus, while known aluminum alloys achieve their intended purpose, there is a need for an improved aluminum alloy that exhibits desirable tensile, creep, and fatigue strength characteristics at elevated operating temperatures and may be in metal casting processes as well used in additive manufacturing processes.

### SUMMARY

According to several aspects, an aluminum alloy is disclosed that is suitable for casting and additive manufacturing for high temperature applications. The disclosed aluminum alloy includes a higher Copper and Magnesium content than conventional aluminum alloys such as A356, 319, and AS7GU. Internal combustion engine components, such as engine blocks and cylinder heads, manufactured of the disclosed aluminum alloy exhibits improved ductility and fatigue properties suitable for elevated operating temperatures in excess of 250° C. The alloy includes by weight about: 4-10% Copper (Cu), 0.1-1.0% Manganese (Mn), 0.2 to 5% Magnesium (Mg), 0.01-1.0% Cerium (Ce), 0.01-2% Nickel (Ni), 0.01-0.8% Chromium (Cr), 0.01-1.0% Zirconium (Zr); 0.01-1.0% Vanadium (V), 0.01-0.3% Cobalt (Co), 0.01-1.0% Titanium (Ti), 1-200 ppm Boron (B), 0.5% max Iron (Fe), 0.1% max other trace elements, and balance of aluminum (Al).

In another aspect of the present disclosure, the alloy includes about: 5-8% Cu, 0.2-0.5% Mn, 0.4-3.0% Mg, 0.1-0.5% Ce, 0.25-1% Ni, 0.25-0.35% Cr, 0.15-0.4% Zr; 0.1-0.3% V, 0.0-0.2% Co, 0.1-0.3% Ti, 70-100 ppm B, 0.15% max Fe, 0.05% max others, and balance of Al.

In another aspect of the present disclosure, the alloy includes a Mg wt % from about 0.2 wt % to the lesser of: [0.75+(0.5*Cu wt %)] wt % or 5 wt %, when Cu is greater than 6 wt %.

In another aspect the alloy includes a Mg wt % from the greater of: 0.2 wt % or (6-Cu wt %) wt %, to the lesser of: (0.75+0.5*Cu wt %) wt % or 5 wt %, when Cu wt % is from about 4 wt % to about 6 wt %.

According to several aspects, an engine component having a cast body formed of a first alloy and an additive manufactured feature having a second alloy printed on to the cast body is disclosed. At least one of the first alloy and the second alloy includes: from about 4.0 to about 10.0 wt % Copper (Cu); from about 0.1 to about 1.0 wt % Manganese (Mn); from about 0.01 to about 1.0 wt % Zirconium (Zr); from about 0.2 to about 5.0 wt % Magnesium (Mg); and a remainder comprising Aluminum (Al).

In another aspect of the present disclosure, the at least one of the first alloy and the second alloy further comprises less than about 0.05 wt % Silicon (Si) and from about 0.001 to about 0.5 wt % Iron (Fe).

In another aspect of the present disclosure, the at least one of the first alloy and the second alloy further comprises at least one element selected from a group consisting of: from about 0.01 to about 2.0 wt % Nickel (Ni); from about 0.01 to about 1.0% Titanium (Ti); from about 0.01 to 0.8 wt % Chromium (Cr); and from about 0.01 to about 0.3 wt % Cobalt (Co).

In another aspect of the present disclosure, the at least one of the first alloy and the second alloy includes a Mg wt % from about 0.2 wt % to a lesser of: [0.75+(0.5*Cu wt %)] wt % or 5 wt %, when Cu is greater than 6 wt %.

In another aspect of the present disclosure, the at least one of the first alloy and the second alloy includes a Mg wt % from a greater of: 0.2 wt % or (6-Cu wt %) wt %, to a lesser of: (0.75+0.5*Cu wt %) wt % or 5 wt %, when Cu wt % is from about 4 wt % to about 6 wt %.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a cross-sectional view of an exemplary internal combustion engine assembly;

FIG. 2 is a calculated phase diagram of an Al—Cu-0.35% Mn-1.6% Mg-1% Ni alloy showing phase transformations as a function of Cu wt % content, according to an exemplary embodiment;

FIG. 3 is a predicted hot Cracking Susceptibility Coefficient (CSC) map during metal casting, according to an exemplary embodiment; and

FIG. 4 is a calculated phase diagram of an Al—Mg-7% Cu-1% Ni-0.35% Mn alloy showing phase transformations as a function of Mg wt % content, according to an exemplary embodiment.

### DETAILED DESCRIPTION

The following description is merely exemplary in nature and is not intended to limit the present disclosure, application, or uses. The illustrated embodiments are disclosed with reference to the drawings, wherein like numerals indicate corresponding parts throughout the several drawings. The figures are not necessarily to scale and some features may be exaggerated or minimized to show details of particular features. The specific structural and functional details disclosed are not intended to be interpreted as limiting, but as a representative basis for teaching one skilled in the art as to how to practice the disclosed concepts.

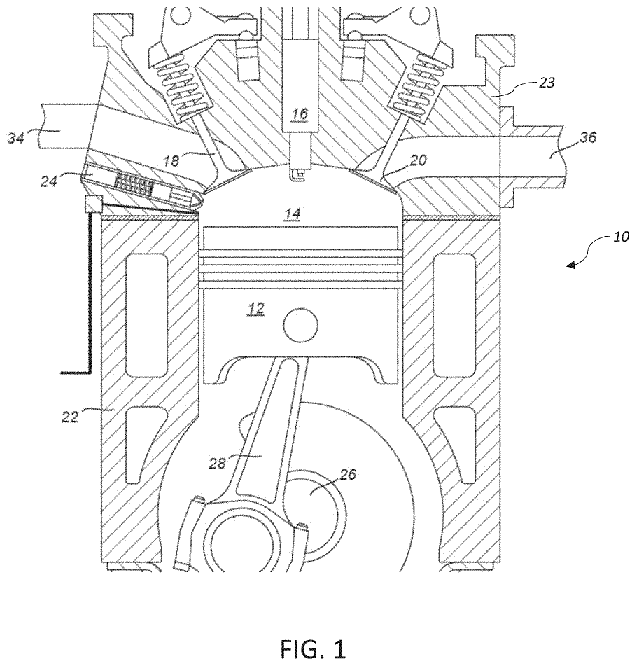

Shown in FIG. 1 is an exemplary internal combustion engine assembly 10 for a vehicle (not shown). The engine assembly 10 includes an engine block 22 defining a plurality of internal cylindrical bores 14, a spark plug 16, an intake valve 18, an exhaust valve 20, a cylinder head 23, and an injector 24. The cylinder head 23 closes the cylinder bores 14 to provide a combustion chamber in each bore 14 in cooperation with a respective piston 12 reciprocating in the bore 14. The piston 12 drives a crankshaft 26 by way of a connecting rod 28, and the intake and exhaust valves 18, 20 are actuated by camshaft. The fuel injector 24 is used to inject fuel directly into the combustion chamber 14. At the appropriate time, a spark is initiated by the spark plug 16 to ignite an air-fuel mixture in the combustion chamber 14. An intake manifold 34 allows air into the combustion chamber 14, and an exhaust manifold 36 allows exhaust escape from the combustion chamber 14.

Modern fuel efficient internal combustion engines, especially engines with direct injections and/or force air inductions, have higher engine power densities, exhaust temperatures, and peak cylinder pressures as compared to conventional engines, resulting in elevated operating temperatures of about 250° C. to 350° C. To accommodate the added stress and strain to the engine assembly 10 due to the elevated operating temperatures, the main body of the engine block 22 and the cylinder head 23 may be manufactured by casting processes using a novel aluminum alloy described in detail below and machined to predetermined tolerances. Intricate features on the engine block 22 and cylinder head 23 formed of the same novel aluminum alloy may be added by additive manufacturing. The novel aluminum alloy has desirable tensile, creep, and fatigue strength properties that will enable the engine assembly 10 to operable in elevated temperatures in excess of 250° C.

Conventional aluminum alloys such as A356, 319 and AS7GU (A356+0.5% Cu) are known to be used for casting engine blocks and cylinder heads of engine assemblies. The A356 alloy is an aluminum alloy with good ductility and fatigue properties at temperatures less than 200° C. However, at above approximately 200° C., creep resistance and tensile strength of the A356 alloy are degraded due to the rapid coarsening of magnesium-silicon (Mg/Si) precipitates. The 319 alloy is a lower cost secondary aluminum alloy used as an alternative to the A356 alloy. The copper-bearing 319 alloy has the advantage of better tensile and creep strength at intermediate temperatures of about 200° C., because the Aluminum-Copper (Al/Cu) precipitates are stable to a higher temperature than the Mg/Si precipitates in A356. However, the 319 alloy is prone to shrinkage porosity due to the high Iron (Fe) and Copper (Cu) content and low ductility at room temperature. The AS7GU alloy is a variant of the A356 alloy and is solid solution strengthened with 0.5 weight percent (wt %) Cu. Similar to the A356 alloy, the AS7GU alloy has good castability while the small copper addition improves creep resistance and tensile strength at intermediate temperatures of about 200° C. Both Mg/Si precipitate in the A356 alloy and Al/Cu precipitate in the 319 alloy are thermally unstable, thus all three alloys have poor mechanical properties above 250° C. due to the rapid coarsening of these precipitates.

The novel aluminum alloy (herein the “Alloy”), described in detail below, enables the casting and machine additive manufacturing of engine components such as the engine block and cylinder heads of internal combustion engine assembly suitable for elevated operating temperatures in excess of 250° C. to about 350° C. An embodiment of a composition of the Alloy is shown in Table 1 below, where all ranges presented are in weight percentage (wt %) unless indicated as part-per-million by weight (ppm):

TABLE 1
Aluminum Alloy

| | | | Preferred | | | | | Preferred | |
|---|---|---|---|---|---|---|---|---|---|
| | Range | | Range | | | Range | | range | |
| Si | <0.05 | | >0 | and <0.03 | Ce | 0.01 | to 1.0 | 0.1 | to 0.5 |
| Cu | 4 | to 10 | 5 | to 8 | Co | 0.01 | to 0.3 | 0.05 | to 0.2 |
| Mg | 0.2 | to 5.0 | 0.4 | to 3.0 | Ti | 0.01 | to 1.0 | 0.1 | to 0.3 |
| Fe | >0 | and <0.5 | >0 | and <0.15 | B | >0 | to 200 ppm | 70 | to 100 ppm |
| Mn | 0.1 | to 1.0 | 0.2 | to 0.5 | Zr | 0.01 | to 1.0 | 0.15 | to 0.4 |
| Ni | 0.01 | to 2.0 | 0.25 | to 1.0 | V | 0.01 | to 1.0 | 0.1 | to 0.3 |

| | | | | | | | |
|---|---|---|---|---|---|---|---|
| Cr | 0.01 | to 0.80 | 0.25 | to 0.35 | Impurities | <0.1 | <0.05 |
| Sr | >0 | to 200 | >0 | to 100 | Al | Remainder | Remainder |

| | |
|---|---|
| ppm | ppm |

The Alloy includes strength enhancement elements such as copper (Cu), magnesium (Mg), manganese (Mn), iron (Fe), zinc (Zn), and nickel (Ni). The microstructure of the alloy includes one or more insoluble solidified and/or precipitated particles with at least one alloying element. A feature of the alloy is the relatively low weight percentage of Silicon (Si) as compared to the conventional aluminum alloys.

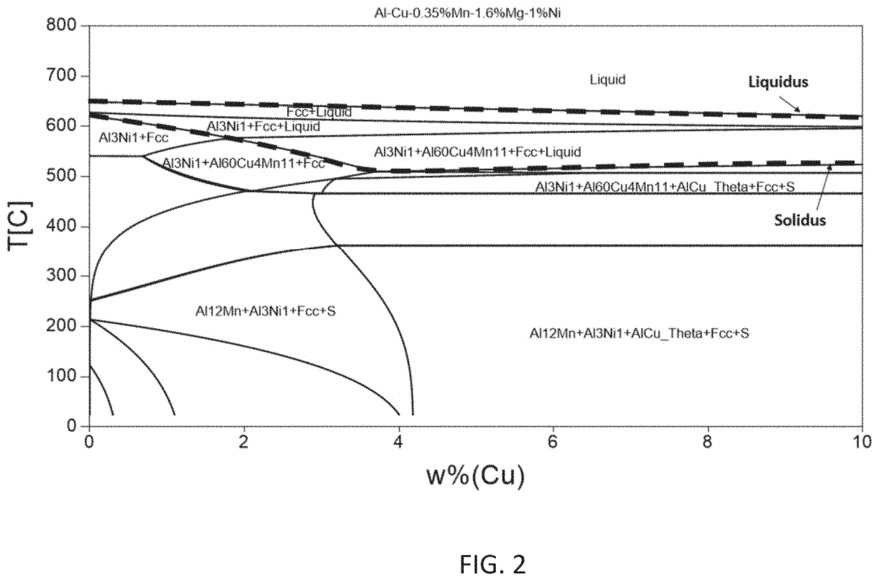

Referring to FIG. 2, which shows the calculated phase diagram of Al—Cu-0.35% Mn-1.6% Mg-1% Ni alloy. Cu is added in the Alloy for precipitation hardening through the formation of Al₂Cu precipitates. Increasing Cu above 5% decreases the freezing range, the temperature between liquidus and solidus (shown in dash-lines). The reduced freezing range decreases alloy shrinkage tendency and improves castability. Mn, Zr, V elements are added to slow down the coarsing of Al₂Cu precipitates when the Alloy is subject to elevated temperatures above 260° C. Contrary to the conventional aluminum alloys, Si in the Alloy is reduced as it helps to coarse the Al₂Cu precipitates and neutralizes the Mn and Zr effect on Al₂Cu precipitates. Ni, Ti, Cr, and Co are added to form nano-scale fine precipitates to further enhance the high temperature properties of the Alloy. Ti, B, Ce may be added to refine the grain structure. The finer the grain sizes, the lower the hot tearing susceptibility and the better castability. Sr is added to modify the Si if there is any present in the alloy.

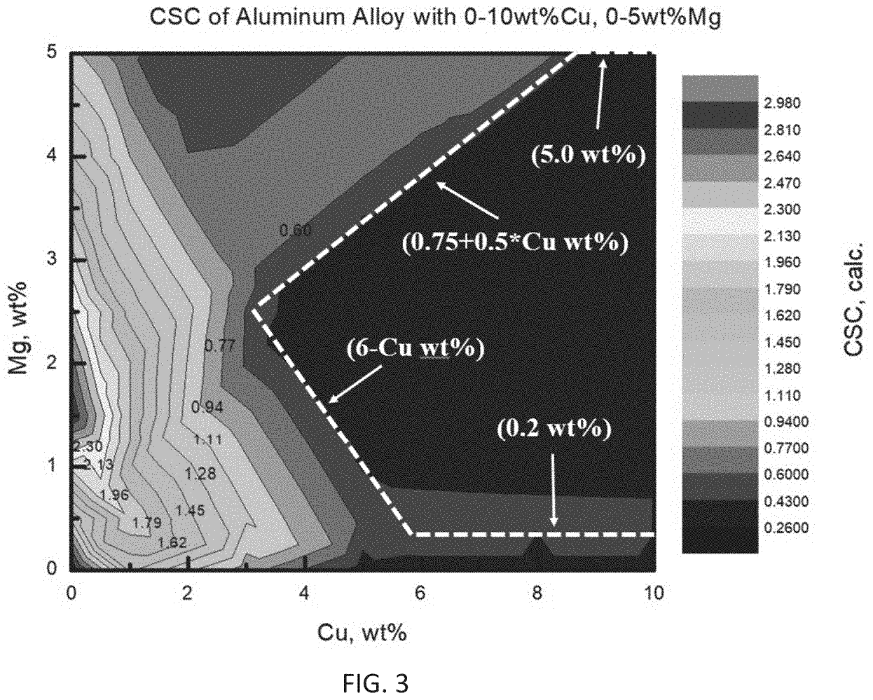

Mg is added to the alloy to reduce hot tearing and density. Shown in FIG. 2 is a predicted hot cracking susceptibility coefficient (CSC) map for the Alloy containing Cu (0-10 wt %) and Mg (0-5 wt %). The preferable Mg content to minimize the alloy hot tearing tendency in the alloy is shown as the regions bounded by the dash lines in FIG. 3. The Alloy contains a Mg wt % from about 0.2 wt % to a lesser of: [0.75+(0.5*Cu wt %)] wt % or 5 wt %, when Cu is greater than 6 wt %. The Alloy contains a Mg wt % from a greater of: 0.2 wt % or (6-Cu wt %) wt %, to a lesser of: (0.75+0.5*Cu wt %) wt % or 5 wt %, when Cu wt % is from about 4 wt % to about 6 wt %.

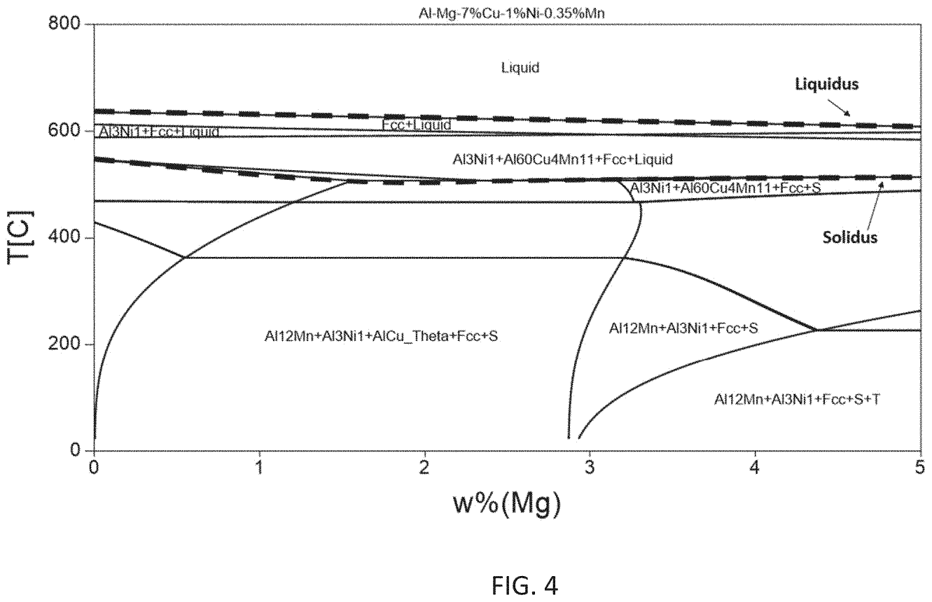

Referring to FIG. 4, which shows a calculated phase diagram of the new aluminum alloy showing phase transformations as a function of Mg content. Addition of magnesium not only enhances the aging response of new aluminum alloy, but also reduces alloy hot tearing tendency during solidification and alloy density. Mg combines Al and Cu to form S phase (Al₂CuMg). The S-phase Al₂CuMg structure has a more active surface than the 8-phase Al₂Cu. The S phase particles can be influenced more in high temperature solution treatment than the 8-phase Al₂Cu, leading to better material properties. As evidence by FIG. 4, there is no Mg₂Si forming in the as-cast microstructure.

The Alloy is suitable for use in casting processes, including but not limited to, lost foam casting, sand casting, precision sand casting, low pressure casting, high pressure die casting, permanent mold casting, semi-permanent mold casting, investment casting, centrifugal casting, squeeze casting, counter gravity/pressure casting. The Alloy is also suitable for use in additive manufacturing (AM), including but not limited to Electron-beam additive manufacturing, or electron-beam melting (EBM), metal selective laser melting (SLM), electron-beam additive manufacturing, or electron-beam melting (EBM), and laser engineered net shaping (LENS). The Alloy can be prepared for AM by first melting an Alloy ingot at a temperature above 750° C., and then atomized into powders with a powder atomizer. It is preferable the powder sizes of the powder range from about 5 micros up to 1.0 millimeters (mm).

The Alloy can be used in the manufacturing of engine components that have high operating temperatures above 250° C., such as the engine block and cylinder head of modern engines. The Alloy may be cast into the basic shape, or main body, of the component. Intricate shapes may be printed onto the basic shape of the component by additive manufacturing by using the same Alloy. As a non-limiting example, the Alloy may be cast into the shape of the cylinder head, the cylinder head is then machined to predetermined tolerances, and then the intricate shape of the valve seats may be printed onto the cylinder head by additive manufacturing. The casting portion of the basic shape offers low cost manufacturing, while the additive manufacturing portion offers intricate shapes having refined microstructure and low porosity as compared with casting. It should be appreciated that the additive manufacturing portion may be applied onto components cast from other aluminum alloys, including but not limited to, A356, 319, and AS7GU (A356+0.5% Cu).

The term “about” used herein means up to +1-10% of the value of the parameter. For example, about 5.0 wt % Magnesium (Mg) may include a range of from 4.5 wt % to 5.5 wt % of Mg. The description of the present disclosure is merely exemplary in nature and variations that do not depart from the general sense of the present disclosure are intended to be within the scope of the present disclosure. Such variations are not to be regarded as a departure from the spirit and scope of the present disclosure.

1. An aluminum alloy, comprising by weight percent (wt %):
from about 4.0 to about 6 wt % Copper (Cu);
from about 0.1 to about 1.0 wt % Manganese (Mn);
from about 0.01 to about 1.0 wt % Zirconium (Zr);
about 5.0 wt % Magnesium (Mg); and
a remainder comprising Aluminum (Al).

2. The aluminum alloy of claim 1, wherein:
Cu is from about 5.0 to about 8.0 wt %;
Mn is from about 0.2 to about 0.5 wt %;
Zr is from about 0.15 to about 0.4%; and
Mg is from about 0.4 to about 3.0 wt %.

3. The aluminum alloy of claim 2, further comprising less than about 0.05 wt % Silicon (Si).

4. The aluminum alloy of claim 1, further comprising less than about 0.05 wt % Silicon (Si).

5. The aluminum alloy of claim 1, further comprising from about 0.01 wt % to about 1.0 wt % Vanadium (V).

6. The aluminum alloy of claim 5, wherein V is from about 0.1 wt % to 0.3 wt %.

7. The aluminum alloy of claim 1, further comprising at least one element selected from a group consisting of:
from about 0.001 to about 0.5 wt % Iron (Fe);
from about 0.01 to about 2.0 wt % Nickel (Ni);
from about 0.01 to about 1.0% Titanium (Ti);
from about 0.01 to 1.0 wt % about Cerium (Ce);
from about 0.01 to 0.8 wt % Chromium (Cr); and
from about 0.01 to about 0.3% Cobalt (Co).

8. (canceled)

9. (canceled)

10. The aluminum alloy of claim 2, wherein the aluminum alloy comprises a powder size of from 5.0 micros to 1.0 millimeters (mm) suitable for additive manufacturing.

11. An engine component, comprising:
a cast body comprising a first alloy; and
an additive manufactured feature printed on to the cast body, wherein the additive manufactured feature comprises a second alloy;
wherein at least one of the first alloy and the second alloy comprises:
from about 4.0 to about 6 wt % Copper (Cu);
from about 0.1 to about 1.0 wt % Manganese (Mn);
from about 0.01 to about 1.0 wt % Zirconium (Zr);
about 5.0 wt % Magnesium (Mg); and
a remainder comprising Aluminum (Al).

12. The engine component of claim 11, wherein the at least one of the first alloy and the second alloy further comprises less than about 0.05 wt % Silicon (Si).

13. The engine component of claim 12, wherein the at least one of the first alloy and the second alloy further comprises from about 0.001 to about 0.5 wt % Iron (Fe).

14. The engine component of claim 12, wherein the at least one of the first alloy and the second alloy further comprises at least one element selected from a group consisting of:
from about 0.01 to about 2.0 wt % Nickel (Ni);
from about 0.01 to about 1.0% Titanium (Ti);
from about 0.01 to 0.8 wt % Chromium (Cr); and
from about 0.01 to about 0.3 wt % Cobalt (Co).

15. (canceled)

16. (canceled)

17. The engine component of claim 12, wherein the other of the at least one of the first alloy and the second alloy is an aluminum alloy selected from a group consisting of an A356 alloy, a 319 alloy, and an AS7GU (A356+0.5% Cu) alloy.

18. The engine component of claim 12, wherein the cast body is a one of a cylinder head or an engine block, and the additive manufacture feature is located on a predetermined portion of the cylinder head or the engine block susceptible to elevated operating temperatures.

19. The engine component of claim 12, wherein the first alloy and the second alloy comprises a same composition.

20. An aluminum alloy suitable for casting and additive manufacturing, consisting essentially of:
from about 4.0 to about 6 wt % Copper (Cu);
from about 0.1 to about 1.0 wt % Manganese (Mn);
from about 0.01 to about 1.0 wt % Zirconium (Zr);
about 5.0 wt % Magnesium (Mg);
less than about 0.05 wt % Silicon (Si); and
a remainder consisting essentially of Aluminum (Al).
